(19) United States
(12) Patent Application Publication
(10) Pub. No.: US 2026/0225264 A1
(43) Pub. Date: Aug. 6, 2026

(54) ROBOT HAND, CONTROL DEVICE, AND ACCOMMODATING CONTAINER

(71) Applicant: Japan Advanced Institute of Science and Technology, Ishikawa (JP)

(72) Inventors: Anh Van HO, Ishikawa (JP); Shinya KAWANO, Ishikawa (JP); Tien Son BUI, Ishikawa (JP); Huu Nhan NGUYEN, Ishikawa (JP); Thanh Khoi NGUYEN, Ishikawa (JP)

(21) Appl. No.: 19/152,344

(22) PCT Filed: Feb. 7, 2024
(86) PCT No.: PCT/JP2024/004179

§ 371 Date: Jul. 30, 2025

(30) Foreign Application Priority Data
Feb. 7, 2023 (JP) 2023-016702

(51) Int. Cl. B25J 15/02; B25J 9/16; B25J 13/08

(52) U.S. Cl. CPC B25J 15/02; B25J 9/1612; B25J 13/088

(57) ABSTRACT

A hand main body (7) of a robot hand (1) has a shape surrounding a grasping space (6), extends from a base end to a free end, and includes a free end portion having an opening (5), and a main body support portion (8) supports a base end portion of the hand main body (7). The hand main body (7) is constituted by a thin film member having flexibility, and has an internal space (9) covered with the thin film member between the base end to the free end portion. In the main body support portion (8), an outer support portion (11) supports a base end portion of an outer peripheral film portion (10), and an inner support portion (13) supports a base end portion of an inner peripheral film portion (12). The robot hand (1) can grasp a target object provided in the grasping space (6) by rotating the inner support portion (13) with respect to the outer support portion (11) about a shaft portion (16), twisting the free end portion of the hand main body (7), and making the opening (5) narrow.

### TECHNICAL FIELD

The present disclosure relates to a robot hand, a control device, and an accommodating container.

### BACKGROUND ART

A robot hand used in various industries such as agriculture and a manufacturing industry has been conventionally known. Patent Literature 1 discloses a robot hand including a plurality of fingertip members that is each coupled to a plurality of link mechanisms supported by an arm mechanism and holds up a work target object. Further, Non Patent Literature 1 discloses a robot hand in which a hard plate having a fold pattern being bent like origami is covered with a thin film made of soft rubber. The robot hand in Non Patent Literature 1 has a structure that is opened by the internal plate being expanded when air is injected into the thin film, and is closed by the internal plate being bent when the air in the thin film is let out.

### CITATION LIST

### Patent Literature

Patent Literature 1: Unexamined Japanese Patent Application Publication No. 2022-189234

### Non Patent Literature

Non Patent Literature 1: Shuguang Li, 6 others, “A Vacuum-driven Origami “Magic-ball” Soft Gripper”, [online], May 2019, Massachusetts Institute of Technology, [Searched on Nov. 16, 2022], Internet <URL: https://dspace.mit.edu/bitstream/handle/1721.1/120930/ICRA19_1887_FI.pdf?sequence=1&isAllowed=y>

### SUMMARY OF INVENTION

### Technical Problem

The robot hand described in Patent Literature 1 is created for a purpose of harvesting a hard and heavy farm product such as, for example, a pumpkin, and is constituted by a hard material in which the fingertip member is less likely to be broken. Thus, there is a risk that the robot hand described in Patent Literature 1 may damage a soft farm product such as, for example, a strawberry when the robot hand grasps the farm product. Further, when the robot hand described in Non Patent Literature 1 is closed, a bent portion of the internal hard plate protrudes, and, similarly to the robot hand described in Patent Literature 1, there is a risk that the robot hand described in Non Patent Literature 1 may damage a soft farm product when the robot hand grasps the farm product.

The present disclosure has been made in view of the circumstances described above, and has an objective to make it less likely to damage a grasped target object.

### Solution to Problem

In order to achieve the objective described above, a robot hand according to the present disclosure includes:
a hand main body that has a shape surrounding a grasping space being a predetermined space when a target object is grasped, extends from a base end to a free end, and includes a free end portion having an opening; and
a main body support portion that supports a base end portion of the hand main body, wherein
the hand main body is constituted by a thin film member having flexibility, and has an internal space covered with the thin film member between the base end to the free end portion,
the main body support portion includes an outer support portion that supports the base end portion of the thin film member disposed outside the internal space, and an inner support portion that supports the base end portion of the thin film member disposed inside the internal space, and
the target object provided in the grasping space is grasped by rotating one of the outer support portion and the inner support portion with respect to the other about a straight line passing through a central portion of the hand main body along an extending direction of the hand main body extending from the base end to the free end, twisting the free end portion, and making the opening narrow.

### Advantageous Effects of Invention

According to the present disclosure, the internal space is provided in the hand main body constituted by the thin film member having flexibility, and thus a part of the thin film member in contact with the target object is in a bent state according to a shape of the target object when the target object is grasped by making the opening narrow. As a result, the robot hand according to the present disclosure can be made less likely to damage the grasped target object than a robot hand whose portion in contact with a target object is not bent when the robot hand grasps the target object. Further, according to the present disclosure, the target object provided in the grasping space can be grasped only by rotating one of the outer support portion and the inner support portion with respect to the other. As a result, the robot hand according to the present disclosure can more easily perform control than a robot hand that cannot grasp a target object provided in a grasping space only by rotating one of an outer support portion and an inner support portion with respect to the other, and a processing load for control can be reduced.

### BRIEF DESCRIPTION OF DRAWINGS

FIG. 1 is an overall explanatory diagram of a robot hand according to Embodiment 1;

FIG. 2 is an enlarged diagram of main portions of the robot hand when viewed from a direction of an arrow II in FIG. 1;

FIG. 3 is a cross-sectional view taken along an III-III line in FIG. 2;

FIG. 4 is an enlarged diagram of main portions in a state where an opening of the robot hand according to Embodiment 1 is closed;

FIG. 5 is a cross-sectional view for describing a method for generating a hand main body and a shaft portion according to Embodiment 1;

FIG. 6 is a cross-sectional view of a robot hand according to Embodiment 2;

FIG. 7 is an enlarged diagram of main portions in an internal space of a hand main body according to Embodiment 2;

FIG. 8 is a diagram illustrating a functional configuration of a control device according to Embodiment 2;

FIG. 9 is a block diagram illustrating a hardware configuration of the control device according to Embodiment 2;

FIG. 10 is a flowchart of gas supply control processing according to Embodiment 2;

FIG. 11 is a cross-sectional view of a robot hand according to Embodiment 3;

FIG. 12 is a diagram illustrating a functional configuration of a control device according to Embodiment 4;

FIG. 13 is a flowchart of harvest motion control processing according to Embodiment 4;

FIG. 14 is a cross-sectional view of a robot hand according to Modification Example 1;

FIG. 15 is an enlarged diagram of main portions in an internal space of a robot hand according to Modification Example 2;

FIG. 16 is a diagram illustrating a state where the robot hand according to Modification Example 2 is disposed above a pen; and

FIG. 17 is a diagram illustrating a state where the robot hand according to Modification Example 2 grasps the pen.

### DESCRIPTION OF EMBODIMENTS

A robot hand and an accommodating container according to embodiments for implementing the present disclosure are described below in detail with reference to drawings. Note that, in the drawings, the same or corresponding portions are denoted with the same reference signs. Further, in order to facilitate understanding of a configuration of the present disclosure, description may be given by describing an X direction of an arrow illustrated in the drawings as “front”, an −X direction as “rear”, a Y direction as “left”, a −Y direction as “right”, a Z direction as “up”, and a −Z direction as “down”.

### Embodiment 1

### (With Regard to Robot Hand 1 According to Embodiment 1)

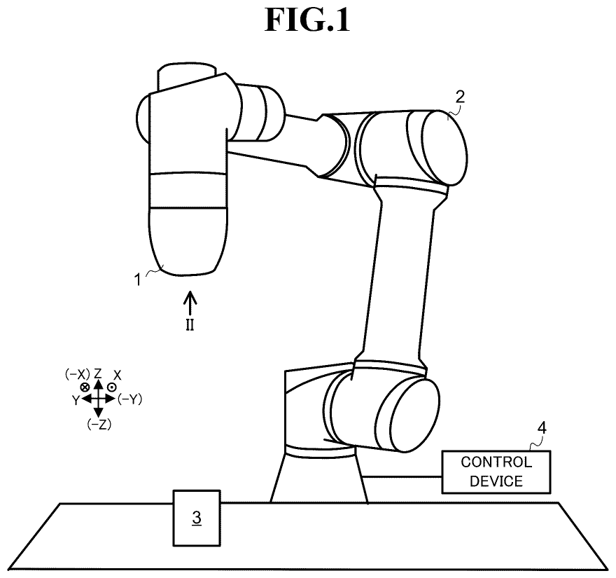

As illustrated in FIG. 1, a robot hand 1 according to Embodiment 1 of the present disclosure is coupled to a free end portion of a robot arm 2. For example, when the robot hand 1 is moved downward to a position of a target object 3 by the robot arm 2, the robot hand 1 can grasp the target object 3 by control from a control device 4 of the robot arm 2. Herein, the target object 3 is, for example, a solid farm product, an aquatic product, a livestock product, a processed food of these, and a mechanical part. In other words, the robot hand 1 can be used for a use such as, for example, harvest of vegetables, fruits, fresh fish, and seaweed, an arrangement of a meal such as noodles and precooked food, and separation, packing, and transportation of processed food and mechanical parts, and is not limited to use on the ground and may be used underwater.

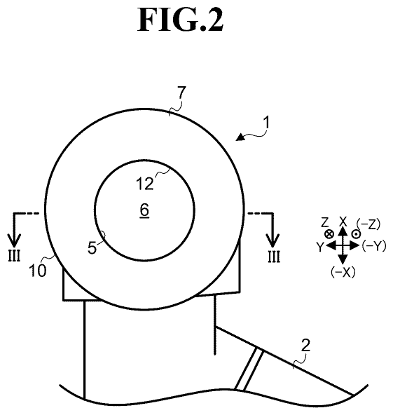

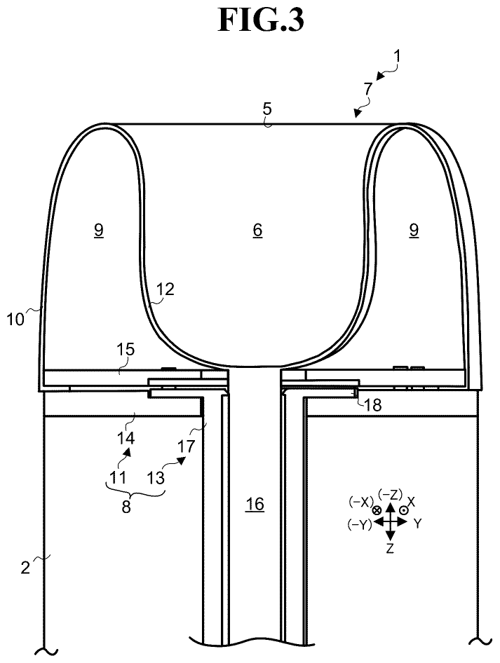

The robot hand 1 has a glass shape, and is designed in advance in such a way that a part or a whole of the target object 3 illustrated in FIG. 1 can enter a grasping space 6 in a cylinder from an opening 5 illustrated in FIG. 2 and provided in a lower end portion as one example of the free end portion. Further, as illustrated in FIG. 3, the robot hand 1 has a cross section in a substantially recessed shape, and includes a hand main body 7 extending from an upper end as one example of a base end to a lower end as one example of a free end, and a main body support portion 8 that supports an upper end portion as one example of a base end portion of the hand main body 7.

The hand main body 7 is constituted by, for example, a thin film member made of silicon that covers an internal space 9 between the upper end to the lower end portion.

The main body support portion 8 is, for example, a rigid member constituted by polylactic acid (PLA) resin. The main body support portion 8 includes an outer support portion 11 that supports an upper end portion of an outer peripheral film portion 10 as one example of the thin film member provided outside the internal space 9, and an inner support portion 13 that supports an upper end portion of an inner peripheral film portion 12 as one example of the thin film member provided inside the internal space 9. In other words, in the hand main body 7, the upper end portion being a base end portion of the outer peripheral film portion 10 and the inner peripheral film portion 12 is supported by the outer support portion 11 and the inner support portion 13 of the main body support portion 8, whereas the lower end portion being a free end portion of the outer support portion 11 and the inner support portion 13 is not supported by the main body support portion 8. Furthermore, the hand main body 7 is not provided with a member that restricts a shape of the hand main body 7 in the internal space 9, such as the hard plate in Patent Literature 1 described above. Thus, a shape on a lower side being a free end side of the hand main body 7 can be freely changed without being restricted by the other member of the robot hand 1.

The outer support portion 11 includes a base 14 that is provided above the internal space 9 and has an annular shape, and a ring plate 15 that is provided inside the internal space 9 and has an annular shape. As illustrated in FIG. 3, the outer support portion 11 supports the upper end portion of the outer peripheral film portion 10 by the base 14 and the ring plate 15 being screwed in a state where the upper end portion of the outer peripheral film portion 10 is sandwiched between an outer peripheral portion of the base 14 and an outer peripheral portion of the ring plate 15.

The inner support portion 13 includes a shaft portion 16 that is integrally provided with the hand main body 7, extends upward from a bottom surface on an upper side of a central portion of the hand main body 7, and has a columnar shape, and a rotation shaft 17 that extends along a straight line in an up-down direction as one example of an extending direction of the hand main body 7, is fixed in a state of surrounding the shaft portion 16 from outward, and has a cylindrical shape. A flange portion 18 that protrudes outward along a radial direction of the rotation shaft 17 and has an annular shape is provided on a lower end portion of the rotation shaft 17. The shaft portion 16 penetrates a central portion of the ring plate 15 and a central portion of the base 14, and the rotation shaft 17 penetrates the central portion of the base 14 in a state where the flange portion 18 is sandwiched between an inner peripheral portion of the base 14 and an inner peripheral portion of the ring plate 15. Further, the flange portion 18 is rotatably supported between the base 14 and the ring plate 15, and the rotation shaft 17 can rotate with respect to the base 14 and the ring plate 15 by control from the control device 4. Thus, the inner support portion 13 can rotate about the shaft portion 16 in a state where a movement in the up-down direction with respect to the outer support portion 11 is restricted.

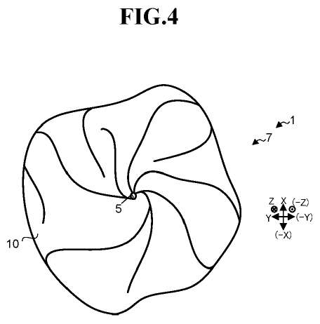

As a result, when the robot hand 1 rotates the rotation shaft 17 forward by a predetermined rotation amount by control from the control device 4, the robot hand 1 enters a state illustrated in FIG. 4 where the upper end portion being the free end portion of the hand main body 7 is twisted and the opening 5 becomes narrow while air in the internal space 9 is let out from the state illustrated in FIG. 2. Thus, when the target object 3 is located in the grasping space 6 in the state illustrated in FIG. 2, the robot hand 1 can grasp the target object 3 by rotating the inner support portion 13 forward with respect to the outer support portion 11 and bringing about the state illustrated in FIG. 4. Note that, when at least a part of the target object 3 is located in the grasping space 6, the robot hand 1 may be able to transport the target object 3 in a state where the robot hand 1 grasps the target object 3. Further, when the robot hand 1 rotates the rotation shaft 17 backward by a predetermined rotation amount by control from the control device 4, the robot hand 1 returns to the state illustrated in FIG. 2 where twist of the upper end portion of the hand main body 7 is released and the opening 5 is provided while the air enters the internal space 9 from the state illustrated in FIG. 4. Thus, when the target object 3 is grasped in the state illustrated in FIG. 4, the robot hand 1 can release the grasped target object 3 by rotating the inner support portion 13 backward with respect to the outer support portion 11 and bringing about the state illustrated in FIG. 2.

### (With Regard to Method for Generating Hand Main Body 7 and Shaft Portion 16 According to Embodiment 1)

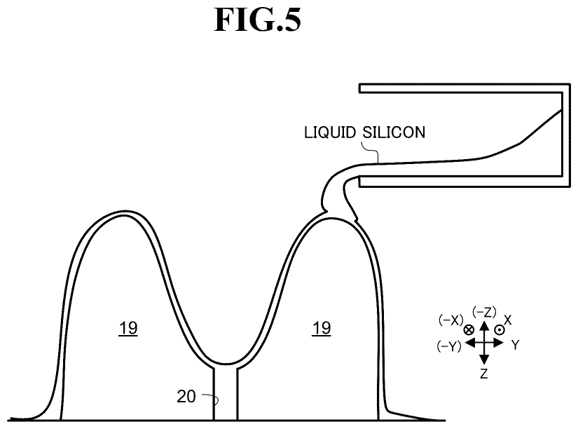

Note that, in the present embodiment, as illustrated in FIG. 5, the hand main body 7 is generated by pouring liquid silicon from above a mold 19 having a glass shape and hardening the silicon on the mold 19. Note that a through hole 20 having a circular cross-sectional shape on an XY plane is provided in a central portion of a bottom surface of the mold 19. Thus, the shaft portion 16 is generated in a state of being integrally provided with the hand main body 7 when the hand main body 7 is generated.

Note that, in the present embodiment, silicon rubber “Dragon Skin (registered trademark) 30” made by Smooth-On, Inc. in America is used as the liquid silicon described above. The silicon rubber has characteristics in which the silicon rubber is an addition curing type, has a small contraction factor during curing, and can be shaped with high dimensional accuracy, and is also used as a material of special effects makeup. Thus, the silicon rubber conceivably has a small bad influence on a human body, and can be conceivably safely used for a use such as harvest of a farm product and an arrangement of food. Furthermore, the silicon rubber also has characteristics in which not only the silicon rubber is restored to an original shape without distortion even after deformation since elasticity is extremely high, but also the silicon rubber is less likely to be broken at both of a time of taking-out from a mold after curing and a time of use since hardness is high.

As described above, according to the robot hand 1 in the present embodiment, the hand main body 7 has a glass shape surrounding the predetermined grasping space 6 when the target object 3 is grasped, extends from the base end to the free end, and includes the free end portion having the opening 5, and the main body support portion 8 supports the base end portion of the hand main body 7. Further, the hand main body 7 is constituted by a thin film member made of silicon having flexibility, and has the internal space 9 covered with the thin film member between the base end to the free end portion. Further, in the main body support portion 8, the outer support portion 11 supports the base end portion of the outer peripheral film portion 10 disposed outside the internal space 9, and the inner support portion 13 supports the base end portion of the inner peripheral film portion 12 disposed inside the internal space 9. Then, the robot hand 1 can grasp the target object 3 provided in the grasping space 6 by rotating the inner support portion 13 with respect to the outer support portion 11 about the shaft portion 16, twisting the free end portion of the hand main body 7, and making the opening 5 narrow.

In this way, in the robot hand 1 according to the present embodiment, the internal space 9 is provided in the hand main body 7 constituted by the thin film member having flexibility, and thus a part of the inner peripheral film portion 12 of the thin film member in contact with the target object 3 is in a bent state according to a shape of the target object when the target object 3 is grasped by making the opening 5 narrow. As a result, the robot hand according to the present disclosure can be made less likely to damage the grasped target object 3 than a robot hand whose portion in contact with a target object is not bent when the robot hand grasps the target object. Further, in this way, in the robot hand 1 according to the present embodiment, the target object 3 provided in the grasping space 6 can be grasped only by rotating the inner support portion 13 with respect to the outer support portion 11, and the grasped target object 3 can also be released only by rotating the inner support portion 13 in an opposite direction with respect to the outer support portion 11. As a result, in the robot hand according to the present disclosure, the control device 4 can more easily perform control than in a robot hand that cannot grasp and release a target object provided in a grasping space only by rotating one of an outer support portion and an inner support portion in a forward direction or a backward direction with respect to the other, and a processing load for control can be reduced.

Further, in the robot hand 1 according to the present embodiment, the hand main body 7 and the shaft portion 16 are generated by pouring the liquid silicon from above the mold 19 and hardening the silicon on the mold 19.

In this way, in the robot hand 1 according to the present embodiment, the hand main body 7 and the shaft portion 16 can be more easily generated at a lower price than in a robot hand in which a hand main body and a shaft portion are not generated by hardening the liquid silicon on the mold 19, and a production cost of the hand main body 7 and the shaft portion 16 can be reduced. As a result, in the robot hand 1 according to the present embodiment, for example, even when the used hand main body 7 and the used shaft portion 16 are frequently exchanged due to use in an environment with strict hygiene maintenance, a cost required for the exchange can be reduced.

### Experimental Example 1

Herein, the inventor performed an experiment for checking whether a farm product can be actually harvested by using the robot hand 1 according to the present embodiment. Specifically, the inventor performed a motion of causing the robot hand 1 to grasp a cap of a mushroom growing from a mushroom bed, then moving the robot arm 2, and separating the robot hand 1 grasping the cap from the mushroom bed. At this time, the inventor himself/herself manually performed checking and adjustment of a position and a posture of the robot hand 1 using the robot arm 2.

### Experimental Result of Experimental Example 1

As a result, it was shown that the robot hand 1 could cut off a root of a stem of the mushroom from the mushroom bed in a state where the stem was exposed from the grasping space 6, and the cap of the mushroom inside the grasping space 6 was not damaged when the stem was cut off from the mushroom bed as long as the cap was not excessively dried.

### Experimental Example 2

Further, the inventor performed a motion of causing the robot hand 1 to grasp a fruit of a strawberry ripening at a tip of a stem of the strawberry, then moving the robot arm 2, and separating the robot hand 1 grasping the fruit from the stem. At this time, similarly to Experimental Example 1 described above, the inventor himself/herself manually performed checking and adjustment of a position and a posture of the robot hand 1 using the robot arm 2.

### Experimental Result of Experimental Example 2

As a result, it was shown that the robot hand 1 could cut off a calyx of the strawberry from the stem in a state where the calyx and a peripheral portion of the calyx were exposed from the grasping space 6, and the fruit inside the grasping space 6 was not damaged when the calyx was cut off from the stem. Further, it was shown that it was easier to cut off the calyx from the stem by causing the robot hand 1 to move in a direction different from a direction in which the stem extends and pull the grasped fruit than to move in the direction in which the stem extends and pull the grasped fruit.

### Experimental Example 3

Further, the inventor also performed an experiment for checking whether a farm product more difficult to harvest than a mushroom and a strawberry can be harvested by using the robot hand 1 according to the present embodiment. Specifically, the inventor performed a motion of causing the robot hand 1 to grasp a fruit of a persimmon ripening on a branch of a persimmon tree, then moving the robot hand 1 grasping the fruit, and separating the fruit from the branch of the tree. At this time, the robot hand 1 was supported by a hand of the inventor instead of the robot arm 2.

### Experimental Result of Experimental Example 3

As a result, it was shown that, even when the robot hand 1 in a state of grasping a calyx of the persimmon and a peripheral portion of the calyx was moved in a direction away from the branch of the tree, grasping could continue without the grasped portion of the fruit falling out of the inside of the grasping space 6, and also the grasped portion of the fruit during harvest was not damaged. However, it was shown that the branch of the persimmon tree was in a state of being pulled together with the fruit only by moving the robot hand 1 in the direction away from the branch, and it was difficult to cut off the fruit from the branch. Then, it was also shown that it was easy to cut off the fruit from the branch of the persimmon tree by fixing the branch in such a way as not to move the branch, then twisting the hand of the inventor supporting the robot hand 1, and moving the robot hand 1 in the direction away from the branch of the tree while continuing a state of grasping the fruit of the persimmon and rotating and moving the entire robot hand 1. Thus, it was shown that the robot hand 1 according to the present embodiment could be used for harvest by performing a motion of plucking the fruit of the persimmon in a state of grasping the fruit on an assumption that the branch of the persimmon tree was fixed.

It was shown from the results that the robot hand 1 according to the present embodiment could be used for harvesting a farm product, and could continue to grasp the farm product without damaging the farm product during harvest.

### Embodiment 2

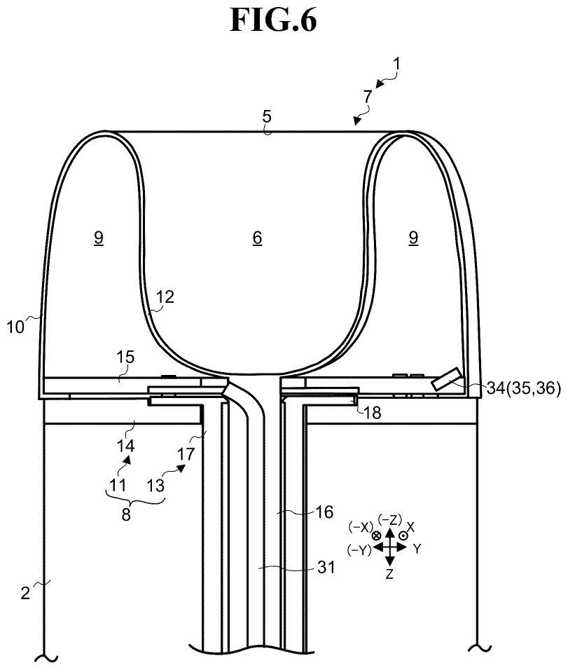

In Embodiment 1, the control device 4 controls grasping and releasing of the target object 3 by controlling forward and backward rotations of the rotation shaft 17, but control of the robot hand 1 by the control device 4 is not limited to this. For example, the control device 4 may perform control for adjusting a state where the robot hand 1 grasps the target object 3. The robot hand 1 and the control device 4 according to Embodiment 2 are described below in detail with reference to FIGS. 6 to 10. Note that, in Embodiment 2, a configuration different from Embodiment 1 is described, and description of the same configuration as Embodiment 1 is omitted due to redundancy.

### (With Regard to Robot Hand 1 According to Embodiment 2)

As illustrated in FIG. 6, the robot hand 1 according to Embodiment 2 of the present disclosure is provided with an air tube 31 as one example of a gas inflow portion that allows the air as one example of gas to flow into the internal space 9. The air tube 31 extends in the up-down direction, penetrates the inside of the rotation shaft 17 together with the shaft portion 16, and includes a lower end portion exposed to the internal space 9. Note that, when the air is supplied to the internal space 9 from the air tube 31, the hand main body 7 can expand the internal space 9.

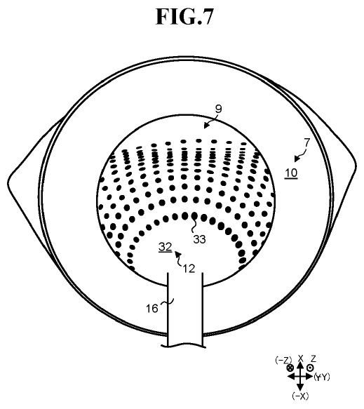

Further, as illustrated in FIG. 7, the hand main body 7 is provided with a plurality of markers 33 on a back surface 32 as one example of an inner surface being a surface of the inner peripheral film portion 12 on a side of the internal space 9. Note that a specific configuration of the plurality of markers 33 is similar to a specific configuration of a plurality of markers disclosed in Unexamined Japanese Patent Application Publication No. 2020-125973 being patent application publication of Japanese Patent Application No. 2019-18391 applied by the applicant of the present specification. Thus, detailed description of the plurality of markers 33 is omitted in order to omit redundant description.

Returning to FIG. 6, a first camera 34 as one example of a first marker image acquisitor that captures the plurality of markers 33, a second camera 35 as one example of a second marker image acquisitor, and a third camera 36 as one example of a third marker image acquisitor are fixed to the ring plate 15. Each of the cameras 34 to 36 is disposed at a predetermined interval being a regular interval from each other. Thus, the control device 4 can acquire a stereo image of the plurality of markers 33 by capturing the plurality of markers 33 from three different points of view of each of the cameras 34 to 36.

### (With Regard to Control Device 4 According to Embodiment 2)

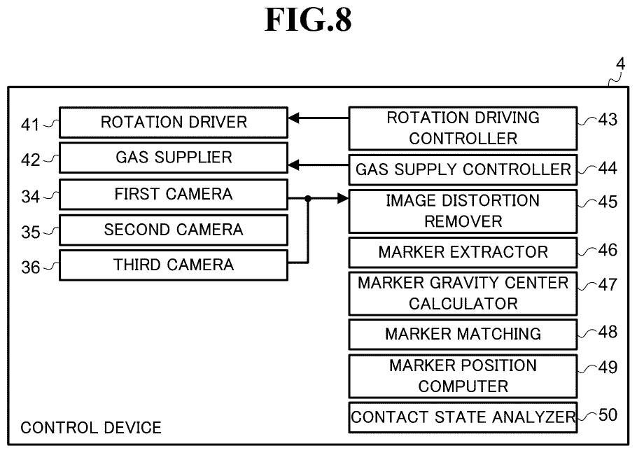

Further, the control device 4 according to the present embodiment is a computer device such as, for example, a personal computer and a tablet terminal. As illustrated in FIG. 8, the control device 4 includes each of the cameras 34 to 36 described above, a rotation driver 41 that rotates the rotation shaft 17, and a gas supplier 42 that can supply the air as one example of the gas to the internal space 9 via the air tube 31. Further, the control device 4 includes a rotation driving controller 43 that controls the rotation driver 41, and a gas supply controller 44 that controls the gas supplier 42. Further, the control device 4 includes an image distortion remover 45 that removes distortion of each image acquired by each of the cameras 34 to 36, a marker extractor 46 that extracts a region of each marker from each image, and a marker gravity center calculator 47 that calculates the center of gravity of each marker. Further, the control device 4 includes a marker matching 48 that associates the same markers in different images, a marker position computer 49 that computes a position of a marker in a three-dimensional space, and a contact state analyzer 50 that analyzes a contact state between the target object 3 and the inner peripheral film portion 12.

(with Regard to Hardware Configuration of Control Device 4 According to Embodiment 2)

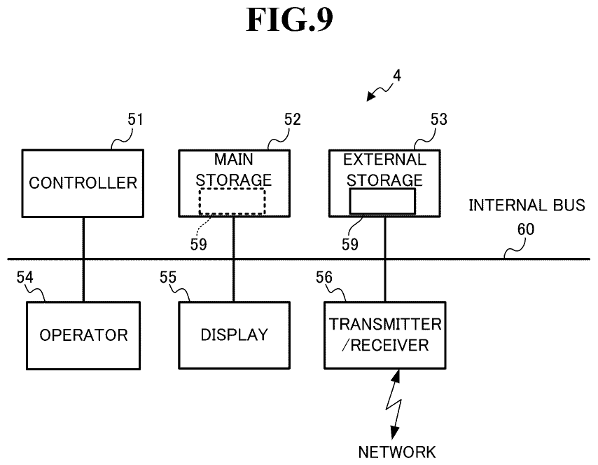

As illustrated in FIG. 9, the control device 4 includes a controller 51 that executes processing according to a control program 59. The controller 51 includes a central processing unit (CPU). The controller 51 functions as the rotation driving controller 43, the gas supply controller 44, the image distortion remover 45, the marker extractor 46, the marker gravity center calculator 47, the marker matching 48, the marker position computer 49, and the contact state analyzer 50 that are illustrated in FIG. 8 according to the control program 59.

Returning to FIG. 9, the control device 4 includes a main storage 52 that loads the control program 59 and is used as a work area of the controller 51. The main storage 52 includes a random access memory (RAM).

Further, the control device 4 includes an external storage 53 that stores the control program 59 in advance. The external storage 53 supplies data stored in the program to the controller 51 according to a command of the controller 51, and stores data supplied from the controller 51. The external storage 53 includes a non-volatile memory such as a flash memory, a hard disk drive (HDD), and a solid state drive (SSD).

Further, the control device 4 includes an operator 54 operated by a user. Input information is supplied to the controller 51 via the operator 54. The operator 54 includes an information input part such as a keyboard, a mouse, and a touch panel.

Further, the control device 4 includes a display 55 that displays information input via the operator 54 and information output from the controller 51. The display 55 includes a display device such as a liquid crystal display (LDC), and an organic electro-luminescence (EL) display.

Further, the control device 4 includes a transmitter/receiver 56 that transmits/receives information. The transmitter/receiver 56 includes an information communication part such as a communication network terminal device connected to a network, and a wireless communication device.

Further, in the control device 4, all of the main storage 52, the external storage 53, the operator 54, the display 55, and the transmitter/receiver 56 are connected to the controller 51 via an internal bus 60.

The control device 4 achieves the function of each of the above-described components 43 to 50 illustrated in FIG. 1 by the controller 51 using, as a resource, the main storage 52, the external storage 53, the operator 54, the display 55, and the transmitter/receiver 56. For example, the control device 4 executes a rotation driving control step executed by the rotation driving controller 43 and a gas supply control step executed by the gas supply controller 44. Further, for example, the control device 4 executes an image distortion removal step executed by the image distortion remover 45, a marker extraction step executed by the marker extractor 46, and a marker gravity center calculation step executed by the marker gravity center calculator 47. Further, for example, the control device 4 executes a marker matching step executed by the marker matching 48, a marker position computation step executed by the marker position computer 49, and a contact state analyze step executed by the contact state analyzer 50.

### (With Regard to Detail of Functional Configuration of Control Device 4 According to Embodiment 2)

Returning to FIG. 8, the rotation driver 41 is constituted by, for example, a stepping motor coupled to the rotation shaft 17, and rotates the rotation shaft 17 about the shaft portion 16.

The gas supplier 42 is constituted by, for example, a compressed air outputter that outputs compressed air being air that is compressed. For example, the gas supplier 42 supplies the air to the internal space 9 by outputting the compressed air via the air tube 31 by the compressed air outputter connected to the air tube 31.

The rotation driving controller 43 controls a rotation direction and a rotation amount of the rotation shaft 17 by controlling rotation driving of the rotation driver 41. Thus, the rotation driving controller 43 can open and close the robot hand 1 by rotating the rotation shaft 17 forward and backward by a predetermined rotation amount.

The gas supply controller 44 controls a supply amount of the air to the internal space 9 by controlling an output of the gas supplier 42.

Note that a specific configuration of the image distortion remover 45, the marker extractor 46, the marker gravity center calculator 47, the marker matching 48, and the marker position computer 49 is similar to a specific configuration of an image distortion remover, a marker extractor, a marker gravity center calculator, a marker matching, and a marker position computer disclosed in Unexamined Japanese Patent Application Publication No. 2020-125973 described above. Thus, detailed description of the components is omitted in order to omit redundant description.

The contact state analyzer 50 computes displacement of the inner peripheral film portion 12, based on a position of each marker in the three-dimensional space being computed by the marker position computer 49, and analyzes a contact state between the target object 3 and the inner peripheral film portion 12, based on the computed displacement of the inner peripheral film portion 12. Note that the gas supply controller 44 controls a supply amount of the air to the internal space 9, based on an analysis result by the contact state analyzer 50. For example, the gas supply controller 44 supplies the air to the internal space 9 until a contact area between the target object 3 and the inner peripheral film portion 12 exceeds a predetermined threshold value.

### (With Regard to Gas Supply Control Processing According to Embodiment 2)

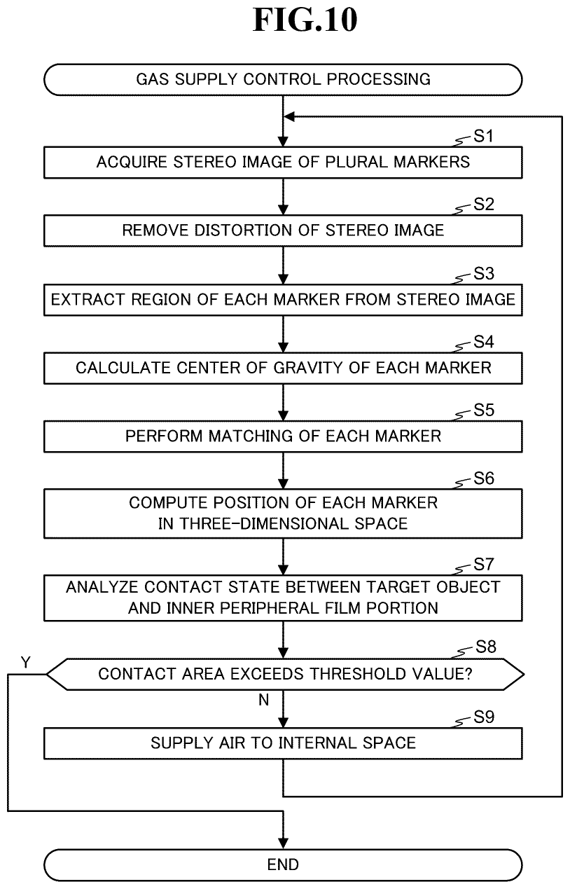

Next, a motion in which the control device 4 supplies the air to the internal space 9 is described in detail. For example, when the rotation driving controller 43 controls rotation driving of the rotation driver 41, rotates the rotation shaft 17 forward by a predetermined rotation amount, and closes the robot hand 1, the control device 4 starts execution of gas supply control processing illustrated in FIG. 10. First, the control device 4 acquires a stereo image of the plurality of markers 33 from each of the cameras 34 to 36 (step S1), the image distortion remover 45 removes distortion of the acquired stereo image (step S2), and the marker extractor 46 extracts a region of each marker of the plurality of markers 33 from the two-dimensional stereo image having distortion removed (step S3).

After extraction of the region of each marker, the marker gravity center calculator 47 calculates the center of gravity of each marker (step S4), and the marker matching 48 performs matching of each marker, based on information about the calculated center of gravity of each marker (step S5). After matching of each marker, the marker position computer 49 computes an actual position of each marker in the three-dimensional space by using data about association of each marker and coordinates of the center of gravity of each marker of the stereo image (step S6). After position computation, the contact state analyzer 50 computes displacement of the inner peripheral film portion 12, based on the computed position of each marker in the three-dimensional space, and analyzes a contact state between the target object 3 and the inner peripheral film portion 12, based on the computed displacement of the inner peripheral film portion 12 (step S7).

After analysis of the contact state, the gas supply controller 44 determines whether a contact area between the target object 3 and the inner peripheral film portion 12 exceeds a threshold value, based on an analysis result by the contact state analyzer 50 (step S8). When the contact area is equal to or less than the threshold value (step S8; N), the gas supply controller 44 supplies the air to the internal space 9 (step S9), returns to step S1, and repeats the processing in steps S1 to S8 until the contact area exceeds the threshold value. Then, when the contact area exceeds the threshold value (step S8; Y), the gas supply controller 44 ends the processing.

As described above, according to the robot hand 1 in the present embodiment, the air tube 31 can cause the air to flow into the internal space 9. Further, when the air is supplied to the internal space 9 from the air tube 31, the hand main body 7 can expand the internal space 9.

In this way, the robot hand 1 according to the present embodiment can change a state of grasping the target object 3, specifically, a contact state between the target object 3 and the inner peripheral film portion 12 by supplying the air to the internal space 9 via the air tube 31 in the state of grasping the target object 3.

Particularly, in the control device 4 according to the present embodiment, the rotation driver 41 rotates the rotation shaft 17 of the inner support portion 13, and the rotation driving controller 43 controls rotation driving of the rotation driver 41. Further, the gas supplier 42 can supply the air to the internal space 9 from the air tube 31, and the gas supply controller 44 controls an output of the gas supplier 42. Further, each of the cameras 34 to 36 acquires an image from three different points of view of the plurality of markers 33 provided on the back surface 32 of the inner peripheral film portion 12, and the marker matching 48 performs matching of each marker included in each image.

Further, the marker position computer 49 computes a position of each marker in the three-dimensional space, based on a correlation between the plurality of markers 33 and each image. Further, the contact state analyzer 50 analyzes a contact state between the target object 3 and the inner peripheral film portion 12, based on displacement of the inner peripheral film portion 12 being computed based on the position of each marker in the three-dimensional space. Then, the gas supply controller 44 supplies the air to the internal space 9 until a contact area between the target object 3 and the inner peripheral film portion 12 exceeds a predetermined threshold value, based on an analysis result by the contact state analyzer 50.

In this way, the control device 4 according to the present embodiment can adjust a contact state between the target object 3 and the inner peripheral film portion 12.

### Embodiment 3

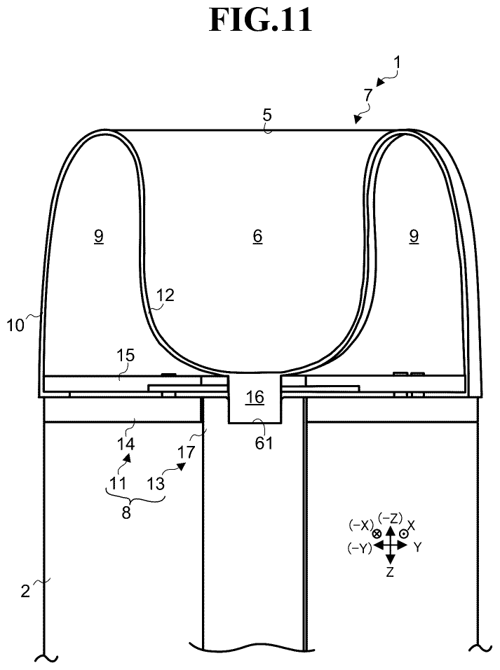

In Embodiments 1 and 2, the robot hand 1 is used in a state of being coupled to the robot arm 2, but may be used in a state of not being coupled to the robot arm 2. The robot hand 1 according to Embodiment 3 is described below in detail with reference to FIG. 11. Note that, in Embodiment 3, a configuration different from Embodiment 1 is described, and description of the same configuration as Embodiment 1 is omitted due to redundancy.

### (With Regard to Robot Hand 1 According to Embodiment 3)

As illustrated in FIG. 11, in the robot hand 1 according to Embodiment 3 of the present disclosure, the shaft portion 16 has a shorter length in the up-down direction than Embodiment 1. Further, the rotation shaft 17 does not include the flange portion 18, and is provided with a shaft fitting hole 61 that is recessed upward from a lower surface and fitted with the shaft portion 16. Thus, in the robot hand 1, when the hand main body 7 is pulled downward by a user, and the shaft portion 16 comes off the shaft fitting hole 61, the base 14 and each portion below the base 14 can be removed from the rotation shaft 17. Further, when the removed robot hand 1 turns upside down, the base 14 can be placed on a floor, a table, and the like.

As described above, according to the robot hand 1 in the present embodiment, the user pulls the shaft portion 16 out of the rotation shaft 17, and thus the base 14 of the robot hand 1 and each portion below the base 14 can be removed from the rotation shaft 17 and the robot arm 2. Further, in a state where the removed robot hand 1 turns upside down, the base 14 can be placed on a floor, a table, and the like.

In this way, the robot hand 1 according to the present embodiment can be used as a packaging container that accommodates the target object 3 when the robot hand 1 is removed from the rotation shaft 17 and the robot arm 2 in a state of grasping the target object 3. Thus, for example, when a farm product is harvested by using the robot hand 1 and the robot arm 2, the user can deliver, to a consumer, the farm product by using the robot hand 1 as it is as an accommodating container of the farm product. Note that the consumer who has received the accommodating container can take the target object 3 out of the packaging container by rotating one of the base 14 and the shaft portion 16 with respect to the other.

### Embodiment 4

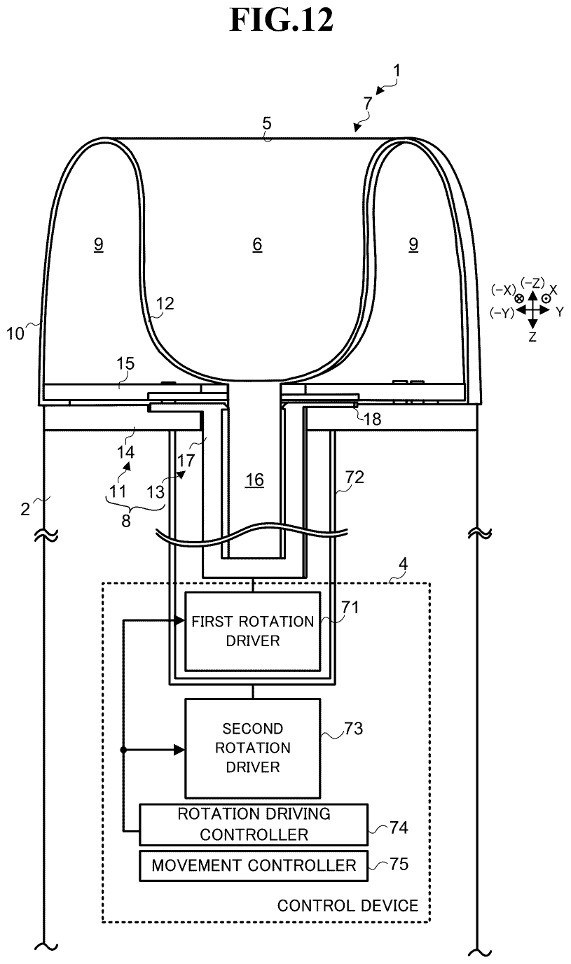

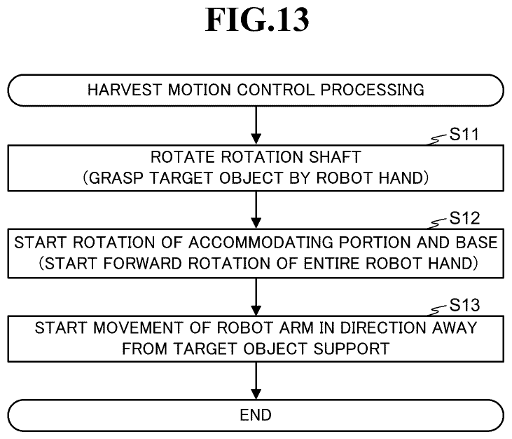

In Experimental Example 3 in Embodiment 1, the motion of plucking a fruit of a persimmon by supporting the robot hand 1 with the hand of the inventor is performed, but a similar motion can also be performed by coupling the robot hand 1 to the free end portion of the robot arm 2. The control device 4 according to Embodiment 4 is described below in detail with reference to FIGS. 12 and 13. Note that, in Embodiment 4, a configuration different from Embodiments 1 and 2 is described, and description of the same configuration as Embodiments 1 and 2 is omitted due to redundancy.

### (With Regard to Control Device 4 According to Embodiment 4)

As illustrated in FIG. 12, in the present embodiment, a first rotation driver 71 coupled to an upper end portion of the rotation shaft 17, an accommodating portion 72 that is fixed to the base 14 and accommodates the first rotation driver 71, and a second rotation driver 73 coupled to an upper end portion of the accommodating portion 72 are provided inside the robot arm 2. The control device 4 according to the present embodiment includes the first rotation driver 71, the second rotation driver 73, a rotation driving controller 74 that controls each of the rotation drivers 71 and 73, and a movement controller 75 that controls a movement of the robot arm 2.

### (With Regard to Hardware Configuration of Control Device 4 According to Embodiment 4)

As illustrated in FIG. 9, similarly to the control device 4 according to Embodiment 2, the control device 4 according to the present embodiment includes the controller 51, the main storage 52, the external storage 53, the operator 54, the display 55, and the transmitter/receiver 56 connected via the internal bus 60. The controller 51 functions as the rotation driving controller 74 and the movement controller 75 that are illustrated in FIG. 12 according to the control program 59. The control device 4 achieves the function of the above-described rotation driving controller 74 illustrated in FIG. 12 by the controller 51 using, as a resource, the main storage 52, the external storage 53, the operator 54, the display 55, and the transmitter/receiver 56. For example, the control device 4 executes a rotation driving control step executed by the rotation driving controller 74 and a movement control step executed by the movement controller 75.

### (With Regard to Detail of Functional Configuration of Control Device 4 According to Embodiment 4)

Returning to FIG. 12, similarly to the rotation driver 41 according to Embodiment 2, the first rotation driver 71 and the second rotation driver 73 are constituted by, for example, a stepping motor provided inside the robot arm 2. The first rotation driver 71 rotates the rotation shaft 17 about the shaft portion 16. The second rotation driver 73 rotates the entire robot hand 1 with respect to the robot arm 2 by rotating the accommodating portion 72 and the base 14 about the shaft portion 16.

The rotation driving controller 74 controls a rotation direction and a rotation amount of the rotation shaft 17 by controlling rotation driving of the first rotation driver 71. Thus, the rotation driving controller 74 can open and close the robot hand 1 by rotating the rotation shaft 17 forward and backward by a predetermined rotation amount. Further, the rotation driving controller 74 controls a rotation direction and a rotation amount of the entire robot hand 1 by controlling a rotation direction and a rotation amount of the accommodating portion 72 and the base 14 by controlling rotation driving of the second rotation driver 73. The rotation driving controller 74 controls the first rotation driver 71, causes the robot hand 1 to grasp the target object 3, then controls the second rotation driver 73, and rotates the entire robot hand 1 in a state where the robot hand 1 grasps the target object 3.

The movement controller 75 controls a movement of the robot arm 2 by controlling a movement mechanism (not illustrated) provided inside the robot arm 2. When the rotation driving controller 74 starts control of the second rotation driver 73, the movement controller 75 moves the robot arm 2 in an upward direction as one example of a direction away from a target object support that supports the target object 3 and is illustrated in FIG. 1.

### (With Regard to Harvest Motion Control Processing According to Embodiment 4)

Next, control by the control device 4 for causing the robot arm 2 coupled to the robot hand 1 to perform a motion of harvesting a farm product is described in detail. For example, when the control device 4 moves the robot arm 2 until a state where the target object 3 is located in the grasping space 6 of the robot hand 1 by control from the movement controller 75, the control device 4 starts execution of harvest motion control processing illustrated in FIG. 13.

First, the rotation driving controller 74 controls rotation driving of the first rotation driver 71, rotates the rotation shaft 17 forward by a predetermined rotation amount, and thus causes the robot hand 1 to grasp the target object 3 (step S11). Further, the rotation driving controller 74 controls rotation driving of the second rotation driver 73, starts a motion of rotating the accommodating portion 72 and the base 14 forward by a predetermined rotation amount, and thus starts forward rotation of the entire robot hand 1 (step S12). Then, the movement controller 75 controls the movement mechanism, and starts a motion of moving the robot arm 2 in the direction away from the target object support that supports the target object 3 (step S13), and ends the processing.

As described above, according to the control device 4 in the present embodiment, the first rotation driver 71 rotates the inner support portion 11 by rotating the rotation shaft 17 about the shaft portion 16. Further, the second rotation driver 73 integrally rotates the outer support portion 11 and the inner support portion 13 of the main body support portion 8 by rotating the accommodating portion 72 and the base 14 about the shaft portion 16. Further, the rotation driving controller 74 controls the first rotation driver 71, causes the robot hand 1 to grasp the target object 3, then controls the second rotation driver 73, and rotates the entire robot hand 1 while maintaining a state where the robot hand 1 grasps the target object 3. Then, when the rotation driving controller 74 starts control of the second rotation driver 73, the movement controller 75 starts control for moving the robot arm 2 in the direction away from the target object support that supports the target object 3.

In this way, for example, when the target object 3 is a farm product such as a fruit ripening on a branch of a tree, the control device 4 can cause the robot arm 2 coupled to the robot hand 1 to perform the motion of plucking the farm product, and the farm product can be harvested.

### Modification Example

Note that, in Embodiments 1 to 4 described above, the configuration in which the robot hand 1 grasps the target object 3 provided below is exemplified, but the present disclosure is not limited to this, and, for example, the robot hand 1 may grasp the target object 3 provided above.

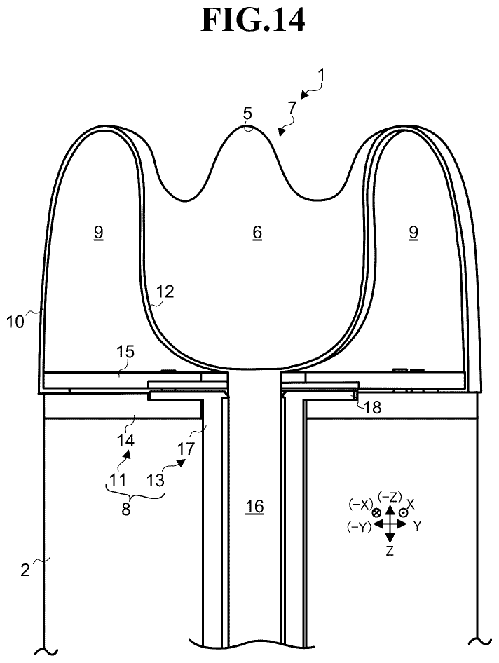

Note that, in Embodiments 1 to 4 described above, the hand main body 7 has a glass shape, but a shape of the hand main body 7 is not limited to this as long as the shape is a shape surrounding the predetermined grasping space 6 when the target object 3 is grasped, and extends from the base end to the free end. For example, as in the robot hand 1 according to Modification Example 1 illustrated in FIG. 14, the lower end portion being the free end portion of the hand main body 7 may have a shape wavy in the up-down direction. In this case, since a shape of the opening 5 when the free end portion of the hand main body 7 is twisted by rotating the rotation shaft 17 in the forward direction changes, a shape of the opening 5 when the lower end portion of the hand main body 7 is twisted can be adjusted by a shape of the free end portion of the hand main body 7.

Note that, in Embodiments 1 to 4 described above, the thin film member constituting the hand main body 7 is provided on a film without irregularities, but a shape of the thin film member is not limited to this. For example, the lower end portion being the free end portion of the hand main body 7 may have a fold pattern. In this case, a shape of a wrinkle when the lower end portion of the hand main body 7 is twisted can be adjusted by the fold pattern, and a shape of the opening 5 can be adjusted. Further, for example, the thin film member may have irregularities. Specifically, a plurality of projection portions having a small diameter may be provided on a surface as one example of an outer surface being a surface outside the inner peripheral film portion 12. In this case, a contact state between the target object 3 and the inner peripheral film portion 12 changes, and frictional force when the robot hand 1 grasps the target object 3 changes as compared to a case where the plurality of projection portions is not provided, and thus the frictional force can be adjusted by the number, an arrangement, and the like of the projection portions.

Further, for example, a hole and a slit may be provided in at least one of the outer peripheral film portion 10 and the inner peripheral film portion 12. Specifically, a plurality of round holes having a small diameter may be provided in the outer peripheral film portion 10 and the inner peripheral film portion 12, and a plurality of slits extending in the up-down direction, a left-right direction, and a direction tilted from the directions may be provided. In this case, the air easily leaks from the internal space when the lower end portion of the hand main body 7 is twisted, and a shape of the robot hand 1 easily changes. Further, in this case, when the opening 5 is made narrow by rotating the inner support portion 13 with respect to the outer support portion 11 and twisting the free end portion of the hand main body 7, the air easily leaks from the internal space. Further, in this case, there is a possibility that a shape of the opening 5 can be adjusted by a size, the number, an arrangement, and the like of a round hole, and an extending direction, a length, the number, an arrangement of a slit, and the like.

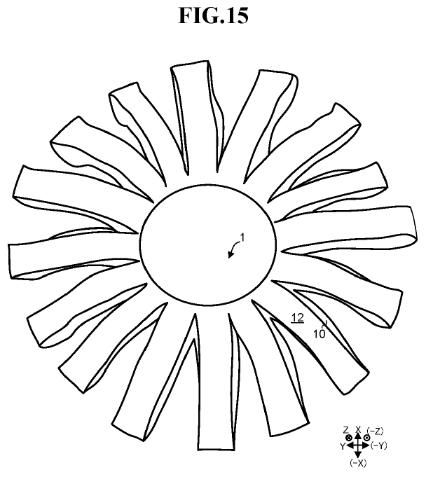

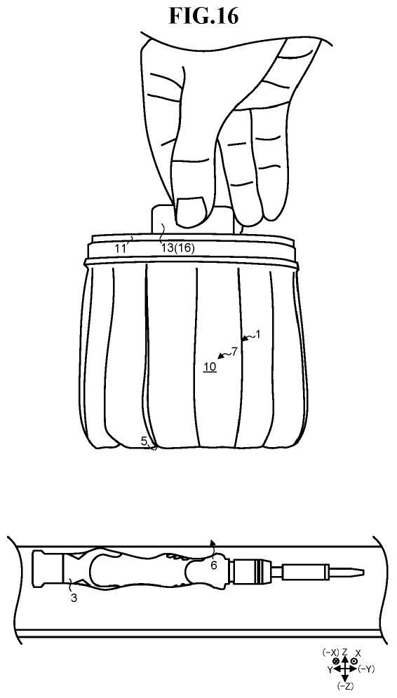

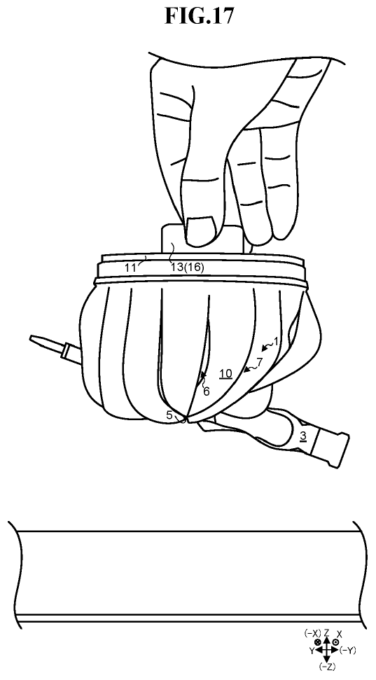

Furthermore, only in a case where the target object 3 provided below is grasped as in Embodiments 1 to 4 described above, but, for example, as in the robot hand 1 according to Modification Example 2 illustrated in FIG. 15, a plurality of notches extending upward being a base end side from a lower end being a free end of a thin film member may be provided as long as the outer peripheral film portion 10 and the inner peripheral film portion 12 are coupled at the free end portion. In this case, as illustrated in FIG. 16, the robot hand 1 according to Modification Example 2 has a shape in which U-shaped thin film members having upper end portions supported by the outer support portion 11 and the inner support portion 13 are aligned in a circumferential direction without a gap. Note that, also in this case, the robot hand 1 according to Modification Example 2 can grasp the target object 3 provided in the grasping space 6 by rotating the inner support portion 13 with respect to the outer support portion 11 about the shaft portion 16, twisting the free end portion of the hand main body 7, and making the opening 5 narrow. In this way, the robot hand 1 according to Modification Example 2 can grasp the target object 3 having a greater width than an inside diameter of the hand main body 7. For example, as illustrated in FIG. 17, even when a pen as the target object 3 longer than the inside diameter of the hand main body 7 is placed on the XY plane, the robot hand 1 according to Modification Example 2 can grasp and lift a central portion of the pen. Note that a width of each thin film member being a length of each U-shaped thin film member in the circumferential direction is not limited to the width in Modification Example illustrated in FIGS. 15 to 17, and can be adjusted to any length. Thus, each thin film member is not limited to a flat rubber shape illustrated in FIGS. 15 to 17, and can also have, for example, a thin thread rubber shape.

Note that, in Embodiments 1 to 4 described above, the hand main body 7 is constituted by the thin film member made of silicon, but a material of the hand main body 7 is not limited to this as long as the thin film member has flexibility. For example, the hand main body 7 may be constituted by a thin film member in which fibers and wire are woven into silicon. In this case, strength of the hand main body 7 improves, and, when the target object 3 is a heavy object, the hand main body 7 is less likely to be torn than the hand main body 7 simply made of silicon.

Note that, in Embodiments 1 to 4 described above, the hand main body 7 and the shaft portion 16 are generated by pouring the liquid silicon from above the mold 19 and hardening the silicon on the mold 19, but a method for generating the hand main body 7 and the shaft portion 16 is not limited to this. For example, the hand main body 7 and the shaft portion 16 may be generated by a 3D printer. In this case, a manufacturer of the hand main body 7 and the shaft portion 16 needs to create design data of three-dimensional computer aided design (CAD) and input the design data to the 3D printer instead of creating the mold 19.

Note that, in Embodiments 1 and 2 described above, the rotation shaft 17 is rotatably supported in a state where the flange portion 18 is sandwiched between the base 14 and the ring plate 15, and thus the inner support portion 13 can rotate in a state where a movement in the up-down direction with respect to the outer support portion 11 is restricted, but the present disclosure is not limited to this. For example, the flange portion 18 of the rotation shaft 17 may be omitted as in Embodiment 3 described above, and then the inner support portion 13 may spirally rotate while moving in the up-down direction with respect to the outer support portion 11.

Note that, as in Embodiment 2 described above, each of the three cameras 34 to 36 is preferably provided in order to acquire all stereo images of the plurality of markers 33 provided on the back surface 32 of the inner peripheral film portion 12, but the number of the cameras may be four or more, and may be two as long as a stereo image can be acquired. Note that, in a case of two cameras, the plurality of markers 33 may be provided only in a range where stereo images of all of the markers can be acquired.

Note that, in Embodiment 2 described above, the air is supplied to the internal space 9 via the air tube 31 in a state where the target object 3 is grasped, but the present disclosure is not limited to this, and, for example, the target object 3 may be grasped by rotating the rotation shaft 17 in a state where the air is supplied to the internal space 9 via the air tube 31 and the internal space 9 is expanded. In this case, the rotation driving controller 43 may rotate the rotation shaft 17 forward until a contact area between the target object 3 and the inner peripheral film portion 12 exceeds a predetermined threshold value, based on an analysis result by the contact state analyzer 50.

Note that, in Embodiment 2 described above, the gas supply controller 44 controls a supply amount of the air to the internal space 9, based on an analysis result of a contact state between the target object 3 and the thin film member by the contact state analyzer 50, but a use of an analysis result by the contact state analyzer 50 is not limited to this. For example, the rotation driving controller 43 may control a rotation amount of the rotation shaft 17, based on an analysis result by the contact state analyzer 50. Further, for example, the control device 4 may determine whether a shape of the grasped target object 3 changes, that is, whether the target object 3 is crushed, and may determine whether the grasped target object 3 is damaged, based on an analysis result by the contact state analyzer 50 and information indicating a characteristic of the target object 3 such as a shape, hardness, and flexibility of the target object 3 being acquired in advance. Further, for example, the control device 4 may determine whether the robot hand 1 can be moved in a state of grasping the target object 3, based on an analysis result by the contact state analyzer 50, information indicating a characteristic of the target object 3 such as a weight of the target object 3 being acquired in advance, and information indicating a characteristic of the hand main body 7 such as a material of the hand main body 7, a frictional coefficient of the surface of the inner peripheral film portion 12, and a load capacity.

Note that, in Embodiment 2 described above, each of the cameras 34 to 36 is attached to the internal space 9 of the hand main body 7 and a contact state between the target object 3 and the thin film member is analyzed, but an image outside the hand main body 7 may be acquired by each of the cameras 34 to 36 and used for control of the robot arm 2 that puts the target object 3 into the grasping space 6. In this case, in order to acquire an image outside the hand main body 7, a degree of transparency of the thin film member constituting the hand main body 7 needs to be increased. Further, for example, a new camera used for control of the robot arm 2 that puts the target object 3 into the grasping space 6 may be attached to the outside of the hand main body 7. In this case, a degree of transparency of the thin film member constituting the hand main body 7 may not be increased.

Note that a portion that mainly executes processing of the control device 4 including the controller 51, the main storage 52, the external storage 53, the operator 54, the transmitter/receiver 56, the internal bus 60, and the like can be realized by using a normal computer system regardless of a dedicated system. For example, the control device 4 that executes the processing described above may be constituted by storing and distributing a computer program for executing the above-described motion into a non-transitory computer-readable recording medium, for example, a flexible disk, a DVD-ROM (read-only memory), and the like, and installing the computer program on a computer. The control device 4 may be constituted by storing the computer program in advance in a storage device included in a server device on a communication network, and downloading the computer program by a normal computer system.

Further, when the function of the control device 4 is realized by sharing of an operation system (OS) and an application program or realized by cooperation with the OS and the application program, only the application program portion may be stored in a non-transitory recording medium or a storage device.

Further, a computer program can be superimposed on a carrier wave and provided via a communication network. For example, the above-described computer program may be posted on a bulletin board system (BBS) on a communication network, and the above-described computer program may be provided via the network. Then, the above-described processing may be executed by activating the computer program and executing the computer program similarly to the other application program under control of the OS.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

This application claims the benefit of Japanese Patent Application No. 2023-16702, filed on Feb. 7, 2023, the entire disclosure of which is incorporated by reference herein.

Reference Signs List

1 Robot hand, 2 Robot arm, 3 Target object, 4 Control device, 5
Opening, 6 Grasping space, 7 Hand main body, 8 Main body
support portion, 9 Internal space, 10 Outer peripheral film portion, 11 Outer
support portion, 12 Inner peripheral film portion, 13 Inner support portion, 14 Base,
15 Ring plate, 16 Shaft portion, 17 Rotation shaft, 18 Flange portion, 19Mold,
20 Through hole, 31 Air tube, 32 Back surface, 33 Plurality of markers, 34
First camera, 35 Second camera, 36 Third camera, 41 Rotation driver
42 Gas supplier, 43 Rotation driving controller, 44 Gas supply controller
45 Image distortion remover, 46 Marker extractor, 47 Marker gravity center
calculator, 48 Marker matching, 49 Marker position computer, 50
Contact state analyzer, 51 Controller, 52 Main storage, 53 External
storage, 54 Operator, 55 Display, 56 Transmitter/receiver, 59 Control
program, 60 Internal bus, 61 Shaft fitting hole, 71 First rotation driver
72 Accommodating portion, 73 Second rotation driver, 74 Rotation driving
controller, 75 Movement controller.

1. A robot hand comprising:
a hand main body that has a shape surrounding a grasping space being a predetermined space when a target object is grasped, extends from a base end to a free end, and includes a free end portion having an opening; and
a main body support portion that supports a base end portion of the hand main body, wherein
the hand main body is constituted by a thin film member having flexibility, and has an internal space covered with the thin film member between the base end to the free end portion,
the main body support portion includes an outer support portion that supports the base end portion of the thin film member disposed outside the internal space, and an inner support portion that supports the base end portion of the thin film member disposed inside the internal space, and
the target object provided in the grasping space is grasped by rotating one of the outer support portion and the inner support portion with respect to the other about a straight line passing through a central portion of the hand main body along an extending direction of the hand main body extending from the base end to the free end, twisting the free end portion, and making the opening narrow.

2. The robot hand according to claim 1, further comprising
a gas inflow portion that allows gas to flow into the internal space,
wherein the hand main body expands the internal space when the gas is supplied to the internal space from the gas inflow portion.

3. A control device that controls the robot hand according to claim 2, the control device comprising:
a rotation driver that rotates the other of the outer support portion and the inner support portion about the straight line;
a rotation driving controller that controls the rotation driver;
a gas supplier that supplies the gas to the internal space from the gas inflow portion;
a first marker image acquisitor that acquires a first image of a plurality of markers provided on an inner surface being a surface of the thin film member on a side of the internal space;
a second marker image acquisitor that acquires a second image of the plurality of markers from a point of view different from the first marker image acquisitor;
a marker matching that associates the plurality of markers included in the first image with the plurality of markers included in the second image;
a marker position computer that computes a position of the plurality of markers in a three-dimensional space, based on a correlation between the plurality of markers associated by the marker matching, the first image, and the second image;
a contact state analyzer that analyzes a contact state between the target object and the thin film member, based on displacement of the thin film member being computed based on the position of the plurality of markers in the three-dimensional space; and
a gas supply controller that controls supply of the gas to the internal space, based on an analysis result of the contact state between the target object and the thin film member.

4. A control device that controls a robot arm coupled to the robot hand according to claim 1, the control device comprising:
a first rotation driver that rotates the other of the outer support portion and the inner support portion about the straight line;
a second rotation driver that rotates the main body support portion about the straight line;
a rotation driving controller that controls the first rotation driver and the second rotation driver; and
a movement controller that controls a movement of the robot arm by controlling a movement mechanism provided inside the robot arm, wherein
the rotation driving controller controls the first rotation driver, causes the robot hand to grasp the target object, then controls the second rotation driver, and rotates the entire robot hand while maintaining a state where the robot hand grasps the target object, and,
when the rotation driving controller starts control of the second rotation driver, the movement controller moves the robot arm in a direction away from a target object support that supports the target object.

5. An accommodating container comprising:
the robot hand according to claim 1, wherein
the accommodating container accommodates the target object.
